(19) United States
(12) Patent Application Publication
(10) Pub. No.: US 2008/0100103 A1
(43) Pub. Date: May 1, 2008

(54) Opening and closing structure of a switch cover for an automotive armrest

(76) Inventor: Sang Ho Kim, Gyeyang-gu (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/647,453

(22) Filed: Dec. 27, 2006

(30) Foreign Application Priority Data
Oct. 31, 2006 (KR) 10-2006-0106441

(51) Int. Cl. B60R 27/00

(52) U.S. Cl. 297/188.19; 296/24.34

(57) ABSTRACT

An opening and shutting structure of a switch cover for an automotive rear armrest is provided. The structure includes a guide unit that is mounted on both sides of the switch cover; and guides the switch cover in such a manner that the right and left movements and gaps are prevented when the switch cover is opened; and a locking unit that is mounted on one side of a body housing, in which the locking member linked with the switch cover is locked or released.

### CROSS-REFERENCE TO RELATED APPLICATION

This application claims priority to Korean Patent application No. 10-2006-0106441, filed on Oct. 31, 2006, in the Korean Intellectual Property Office, the disclosure of which is incorporated herein by reference.

### BACKGROUND OF THE INVENTION

1. Field of the Invention

The present invention relates to an opening and closing structure of a switch cover for an automotive armrest.

2. Description of the Related Art

Generally, in the case of expensive automobiles, an armrest is arranged in the middle of the rear seat such that a passenger can put his arm on it, thereby resting his/her arm.

In forming such an armrest, according to the conventional art, the lower side of the armrest is used as a hinge in the center of the seatback of the rear seat so as to make the rotation possible.

As such, when the passenger wants to use the armrest, the passenger unfolds the armrest. When the passenger does not want to use the armrest, the passenger folds the armrest.

The armrest includes an operation switch that can operate windows, the audio, and the TV. A switch cover covers the operation switch which is rotated through the hinge to be opened and closed.

However, the aesthetics of the conventional armrest is not aesthetically pleasing. Furthermore, the conventional armrest damages the locking structure o the armrest because the hinge point can be reduced to a single one. Quite surprisingly, the present invention solves these problems.

### SUMMARY OF THE INVENTION

The present invention provides an opening and closing structure of a switch cover for an automotive armrest in which the switch cover is operated by a guide unit, and a locking unit which is mounted within the body housing and at the side. The present invention improves the aesthetic of the armrest. The present invention also prevents damage by the locking structure because the hinge point can be reduced to a single one.

In one embodiment of the present invention, an opening and closing structure of a switch cover for an automotive armrest is provided. The structure includes a guide unit that is mounted on both sides of the switch cover. The guide unit guides the switch cover in such a manner that the lateral (i.e., right and left) movements and gaps are prevented when the switch cover is opened. Furthermore, a locking unit that is mounted on one side of a body housing, in which the locking member is linked with the switch cover, is locked or released.

In an exemplary embodiment, it is preferable that the guide unit includes a link fixed on both sides of the switch cover. A link guide is formed on one side of the body housing, and includes a guide hall in which a projection pin fixed on one side of the link, is inserted and guided.

In an exemplary embodiment, the locking unit includes a suspending projection that is formed at the end part of the link; a fixing hook that fixes or releases the suspending projection by the pressing operation of the suspending projection; and a body that repeats the operation in which the fixing hook is inserted and separated.

In an exemplary embodiment, the link is fixed on the fixing unit which is formed on both sides of the inner cover portion of the switch cover having inside and outside cover portions.

### BRIEF DESCRIPTION OF THE DRAWINGS

FIGS. 1 and 2 are perspective views illustrating the opening and closing structure of a switch cover for a rear armrest.

FIG. 3 is a perspective view illustrating the mounting structure of a link fixed on the switch cover according to the present invention.

FIG. 4 is a series of diagrams which illustrate the operation of the opening and closing structure of the switch cover for the rear armrest according to the present invention.

FIG. 5 is a perspective view illustrating the opening and closing structure of a switch cover for a rear armrest according to the conventional art.

### DETAILED DESCRIPTION OF THE INVENTION

Hereinafter, preferred embodiments of the present invention will be described with reference to the attached drawings.

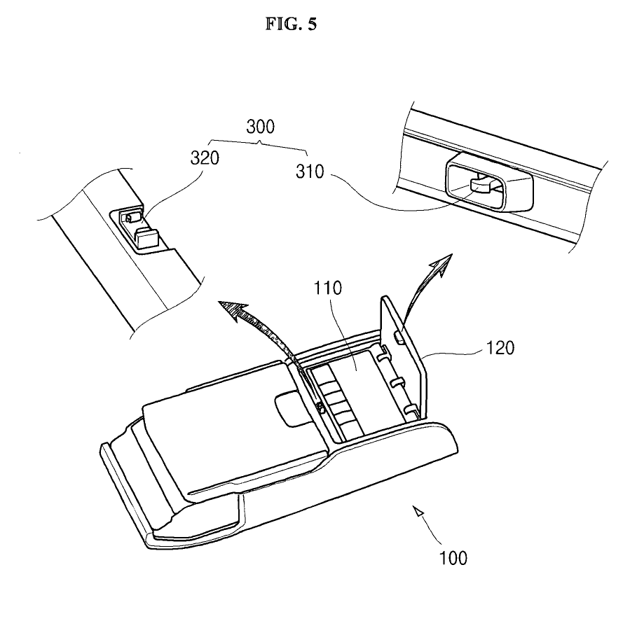

The conventional body housing where the switch cover and the switch are contained includes the opening and closing unit, as illustrated in FIG. 5. When the fixing hook 320 is installed on the body housing 110, and the suspending projection 310 is installed on one side of the body housing 110, by which the center of the switch cover 120 is pressed by a finger, the suspending projection 310 is released from the fixing hook 320, whereby the switch cover 120 is opened by the force of the spring mounted on the hinge 140.

Because the locking unit 300, which is a push locking device, is projected on the rear armrest 100 surface, the passenger can be injured by the locking structures 310 and 320 when the switch cover 120 is operated.

The present invention includes a lock unit 30. When the center of the switch cover 12 is pressed by a finger, the switch cover is released from the push locking device, thereby opening the switch cover 12 by the force of the spring mounted on the hinge 13. A guide unit 20 guides the switch cover 12 in such a manner that the lateral (i.e., right and left) movements and gaps are prevented when the switch cover 12 is rotated.

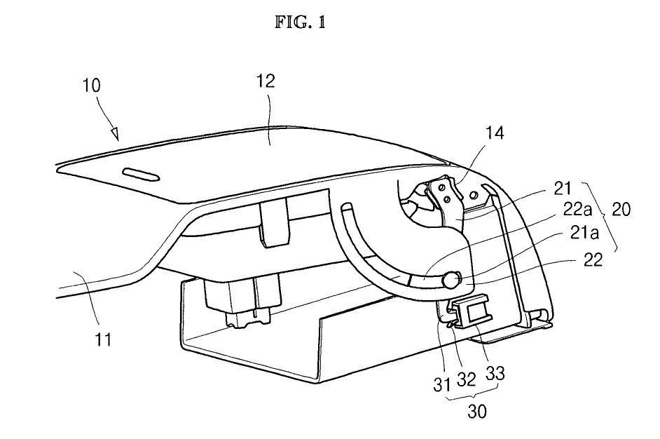

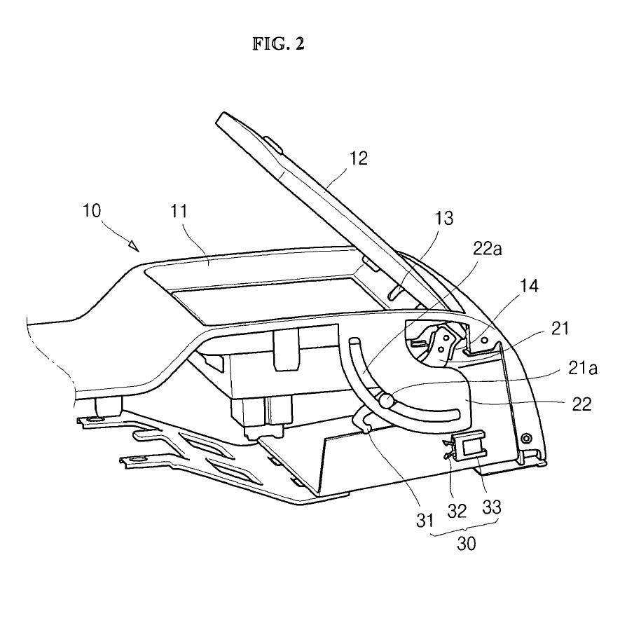

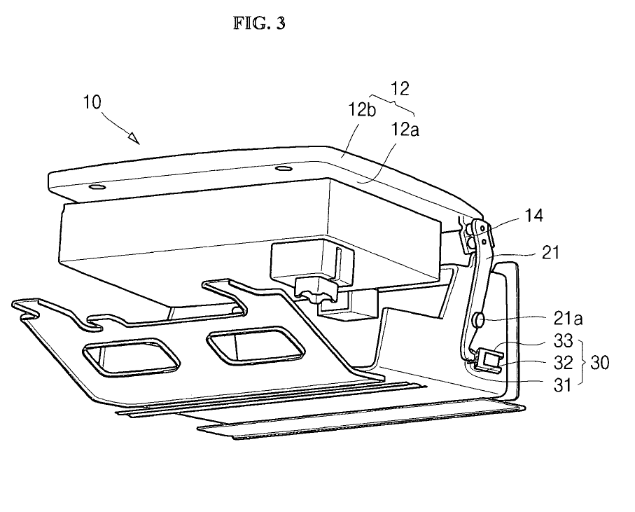

Specifically, as illustrated in FIGS. 1-3, the switch cover 12 includes an external covering unit 12b at the uppermost side, an internal covering unit 12a at the inside, and a fixing unit 14 in which the end part of one side of the link 21 is fixed at the right and left sides of the internal covering unit 12a.

In the case where the switch cover 12 is rotated, the link is also rotated along the trace of the rotation of the switch cover 12. In the case where the switch cover 12 is opened, and the link is rotated, the link guide 22 that determines the maximum opening angle and the shutting angle while preventing the lateral movements and gaps of the link is integrally formed at one side of the body housing 11 of the rear armrest 10.

Here, the projection pin 21a is fixed at one side of the link 21 which is inserted to the guide hall 22a in such a manner that the link 21 can move along the guide hall 22a formed on the link guide 22.

In the case where the link 21 is rotated and the switch cover 12 is opened, the guide hall 22a of the link guide 22 is integrally formed on the body housing 11 and handles the movements and gaps of the link 21. Therefore, the rotation is done stably.

Furthermore, a suspending projection 31 and a locking member is included at the end part of the second side of the link 21 in such a manner that the switch cover 12 is locked by the locking unit 30 in the closed state.

Here, the locking unit 30 is a push locking device that is mounted on one side of the body housing 11, and is constituted in such a manner that the fixing hook 32 is repeatedly inserted into or separated from the body 32 by the pressing of the suspending projection 31 formed at one side of the link 21.

The push locking device is well known to one of ordinary skill in the art.

Hereinafter, the operation of the opening and closing structure of the switch cover for the rear armrest according to the present invention is described in the following.

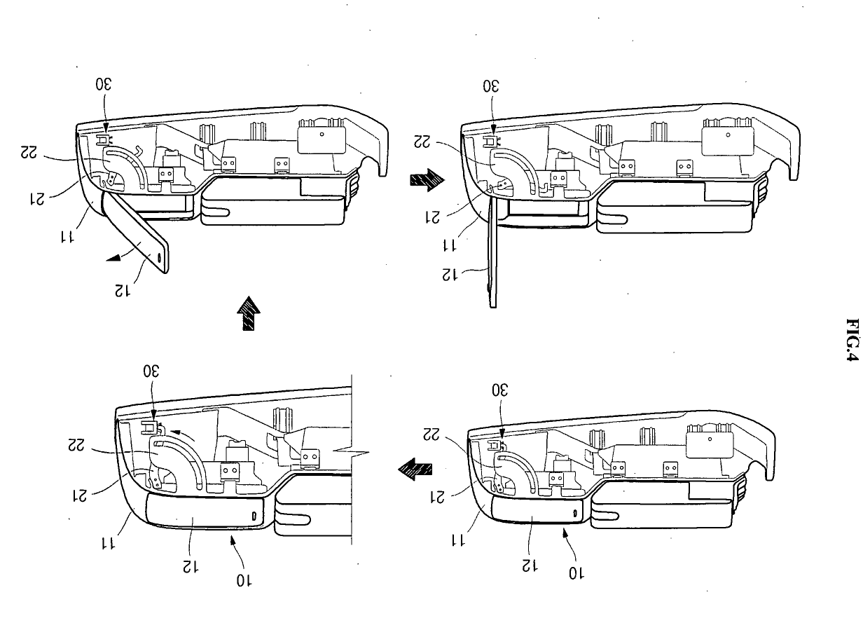

In FIG. 4, when the passenger sits on the rear seat and unfolds the rear armrest 10, the passenger opens the switch cover 12 so as to operate windows, the audio equipment, or the TV. If a passenger presses the center of the switch cover 12, the suspending projection 31 at one end of the link 21 is connected to the switch cover 12 which is released from the push locking device, and the switch cover 12 is opened by the force of the spring (not shown).

Consequently, by pressing the suspending projection 31, the fixing hook 32 is inserted into the inside of the body 33, and the suspension is released. If the force that presses the switch cover 12 is removed, the fixing hook 32 is separated from the outside of the body 33, and the suspension projection 31 is released.

As such, in the case where the suspending projection 31 is separated from the push locking device, the link 21 that includes the suspending projection 31 is rotated along with the opening operation of the switch cover 12, and is thus stably rotated along the guide hall 22a of the link guide which is integrally formed on the body housing 11.

In contrast, when the switch cover 12 is closed, if the center of the switch cover 12 is pressed by a finger, the link connected to the switch cover 12 is guided along the link guide 21, and is inserted between the fixing hook 32 of the push locking device. At the same time, as the fixing hook 32 is pushed into the inside of the body 33, the fixing hook 32 is inserted inside of the body, whereby the suspending projection 31 is not released, and is fixed on the fixing hook 32.

As described above, the preferred embodiment of the present invention is disclosed through the descriptions and the drawings. The terms are used not to define the meanings thereof or restrict the scope of the present invention described in the claims but to explain the present invention. Therefore, it would be appreciated by those skilled in the art that changes might be made in this embodiment without departing from the principles and spirit of the invention, the scope of which is defined in the claims and their equivalents.

What is claimed is:

1. An opening and closing structure of a switch cover for an automotive armrest, the structure comprising:
a guide unit that is mounted on both sides of the switch cover, and guides the switch cover in such a manner that the lateral movements and gaps are prevented when the switch cover is opened; and
a locking unit that is mounted on one side of a body housing, in which the locking member linked with the switch cover is locked or released.

2. The structure according to claim 1, wherein the guide unit further comprises:
a link fixed on both sides of the switch cover; and
a link guide that is formed at one side of the body housing, and includes a guide hall in which a projection pin fixed on one side of the link is inserted and guided.

3. The structure according to claim 1, wherein the locking unit comprises:
a suspending projection that is formed at the end part of the link;
a fixing hook that fixes or releases the suspending projection by the pressing operation of the suspending projection; and
a body that repeats the operation in which the fixing hook is inserted and separated.

4. The structure according to claim 2, wherein the link is fixed on the fixing unit formed at both sides of the inner cover portion of the switch cover having inside and outside cover portions.
